(19) United States
(12) Patent Application Publication
(10) Pub. No.: US 2022/0004657 A1
(43) Pub. Date: Jan. 6, 2022

(54) SECURE AND ACCOUNTABLE DATA ACCESS

(71) Applicant: Trade Examination Technologies, Inc., Wheaton, IL (US)

(72) Inventors: Drew F. Orsinger, Charlotte, NC (US); Trevor J. Orsinger, Wheaton, IL (US); Joshua Hoffberg, Highland Park, IL (US)

(21) Appl. No.: 17/292,564

(22) PCT Filed: Nov. 15, 2019
(86) PCT No.: PCT/US2019/061812

§ 371 Date: May 10, 2021

Related U.S. Application Data
(60) Provisional application No. 62/917,036, filed on Nov. 15, 2018.

(51) Int. Cl. G06F 21/62; G06Q 30/04

(52) U.S. Cl. CPC G06F 21/6245; G06Q 30/04

(57) ABSTRACT

Methods and systems for controlling access to data. One method includes storing, by an electronic processor, a registration record for a user in a database identifying a first user device associated with the user. A data access request from the first user device is authenticated by the electronic processor based on the registration record. A key is provided by the electronic processor to the first user device responsive to authenticating the data access request. Data obfuscated with the key is sent to the first user device. A consumption record is stored in the database responsive to an employing of the key to de-obfuscate the data.

### CROSS REFERENCE TO RELATED APPLICATIONS

This application claims the benefit of U.S. Provisional Patent Application No. 62/917,036, filed on Nov. 15, 2018, the contents of which are hereby incorporated by reference in their entirety.

### FIELD OF DISCLOSURE

Embodiments described herein relate to controlling access to data, such as streaming data. More particularly, embodiments described herein relate to systems and methods for providing secure and accountable access to data using, in some embodiments, a distributed ledger.

### SUMMARY

As the world becomes more digitized and easily-accessible, data providers need to be able to enforce controls or otherwise account for data to stem the unwitting redistribution of data, such as data distributed through multicast data streams. Multicast protocols allow streaming to multiple users, but it is difficult to track and audit data usage. It is also important that authentication techniques may be used in a low-latency environment, since the value of the data is sometimes associated with its timeliness.

Accordingly, embodiments described herein provide security and accountability in data access, such as data streaming. In some embodiments, data published from a multicast source are authenticated, verified, and secured by participants entitled to receive those data streams. Third parties that are not authorized to view the data are identified to allow data suppression so that the party cannot view the data or to facilitate billing to allow the third party to use the data. The systems and methods described herein also identify “cross-pollination” of data, where the primary consumer who holds a valid subscription to the data intentionally or inadvertently replicates and releases the originally-sent data, providing it to downstream consumers, such as within the same Local Area Network (“LAN”).

In particular, one embodiment provides a method for controlling access to data. The method includes storing, by an electronic processor, a registration record for a user in a database identifying a first user device associated with the user. A data access request from the first user device is authenticated by the electronic processor based on the registration record. A key is provided by the electronic processor to the first user device responsive to authenticating the data access request. Data obfuscated with the key is sent to the first user device. A consumption record is stored in the database responsive to an employing of the key to de-obfuscate the data.

Another embodiment provides a system for controlling access to data. The system includes an electronic processor and memory coupled to the electronic processor. The memory stores instructions. The instructions, when executed by the electronic processor, cause the system to store a registration record for a user in a database identifying a first user device associated with the user, authenticate a data access request from the first user device based on the registration record, provide a key to the first user device responsive to authenticating the data access request, send data obfuscated with the key to the first user device, and store a consumption record in the database responsive to an employing of the key to de-obfuscate the data.

Other aspects of the disclosure will become apparent by consideration of the detailed description and accompanying drawings.

### BRIEF DESCRIPTION OF THE DRAWINGS

FIG. 1 illustrates an example system for controlling access to data, according to some embodiments.

FIG. 2 is a diagram illustrating data flow between a data portal and a user device in the system of FIG. 1, according to some embodiments.

FIG. 3 is a flowchart illustrating an example method for controlling access to data performed by the system of FIG. 1, according to some embodiments.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used herein, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

Also, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

Data providers, such as financial exchanges, generate enormous amounts of proprietary data, derived from market activity (e.g., bids and offers, buys and sells, and settlement prices). This data is valuable to numerous primary consumers, as well as secondary and tertiary participants. Regardless of whether users rely on “real-time,” “delayed,” “reference,” or “historical” data, protection of that information is important to the data provider (e.g., the exchange) as a key source of revenue. Conversely, it is important for consumers of data to stay compliant, ensuring only end-node systems that committed to purchasing the data receive the data during a specific period of time. Due to the lack of security and accountability, producers of market data potentially lose hundreds of millions of dollars in revenue due to lack of audit controls and unauthorized consumption by unregistered users. In particular, subscription-based data services have an innate lack of accountability. For example, in many situations, once a consumer purchases data, there is nothing stopping the consumer from sending that data to other individuals, either for free or for a profit. Accordingly, when third parties get unrestricted access to data, sellers and producers have no means of recouping lost revenue as data sellers and producers do not have an efficient mechanism to track secondary use of data, making it very difficult to accurately and efficiently reconcile the individual contracts with the buyers.

As noted above, it is also difficult to implement secure data streaming in a low latency environment. Conventional security techniques, such as encryption using public and private keys, introduces significant latency in the process for delivering streaming data, which reduces the value of the data.

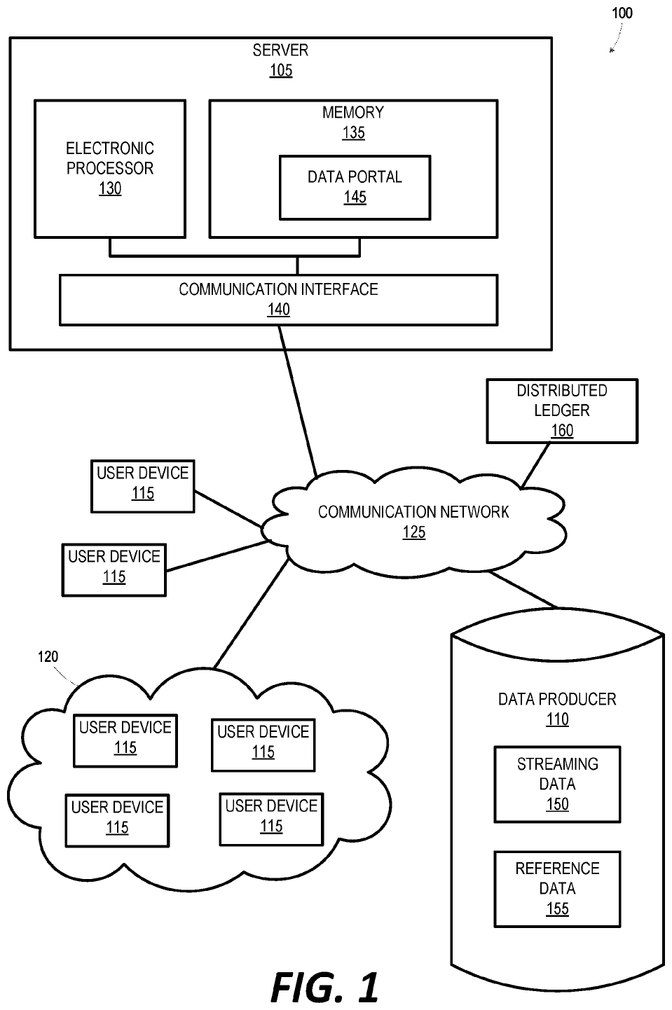

To address these and other issues, embodiments described herein provide systems and methods for providing secure and accountable access to data, such as but not limited to streaming data. For example, FIG. 1 illustrates a system 100 for controlling access to data, according to some embodiments. The system 100 includes a server 105, a data producer 110, and user devices 115. In some embodiments, some of the user devices 115 are stand-alone devices, and others are present as part of a user network 120. In some embodiments, the system 100 includes fewer, additional, or different components than illustrated in FIG. 1. For example, the system 100 may include multiple servers 105, data producers 110, user devices 115, user networks 120 or a combination thereof.

The server 105, the data producer 110, and the user devices 115 communicate over one or more wired or wireless communication networks 125. Portions of the communication network 125 may be implemented using a wide area network, such as the Internet, a local area network, such as a Bluetooth™ network or Wi-Fi, and combinations or derivatives thereof. Alternatively or in addition, in some embodiments, components of the system 100 communicate directly as compared to through the communication network 125. Also, in some embodiments, the components of the system 100 communicate through one or more intermediary devices not illustrated in FIG. 1.

The server 105 is a computing device that may serve as a gateway for communicating data from the data producer 110 to the user devices 115. As illustrated in FIG. 1, the server 105 includes an electronic processor 130, a memory 135, and a communication interface 140. The electronic processor 130, the memory 135, and the communication interface 140 communicate wirelessly, over one or more communication lines or buses, or a combination thereof. The server 105 may include additional components than those illustrated in FIG. 1 in various configurations. The server 105 may also perform additional functionality other than the functionality described herein. Also, the functionality described herein as being performed by the server 105 may be distributed among multiple devices, such as multiple servers included in a cloud service environment. In addition, in some embodiments, the user device 115 may be configured to perform all or a portion of the functionality described herein as being performed by the server 105.

The electronic processor 130 includes a microprocessor, an application-specific integrated circuit (ASIC), or another suitable electronic device for processing data. The memory 135 includes a non-transitory computer-readable medium, such as read-only memory (ROM), random access memory (RAM) (for example, dynamic RAM (DRAM), synchronous DRAM (SDRAM), and the like), electrically erasable programmable read-only memory (EEPROM), flash memory, a hard disk, a secure digital (SD) card, another suitable memory device, or a combination thereof. The electronic processor 130 is configured to access and execute computer-readable instructions (“software”) stored in the memory 135. The software may include firmware, one or more applications, program data, filters, rules, one or more program modules, and other executable instructions. For example, the software may include instructions and associated data for performing a set of functions, including the methods described herein. For example, as illustrated in FIG. 1, the memory 135 may store instructions for implementing a data portal 145.

The communication interface 140 allows the server 105 to communicate with devices external to the server 105. For example, as illustrated in FIG. 1, the server 105 may communicate with the data producer 110 through the communication interface 140. In particular, the communication interface 140 may include a port for receiving a wired connection to an external device (for example, a universal serial bus (USB) cable and the like), a transceiver for establishing a wireless connection to an external device (for example, over one or more communication networks 125, such as the Internet, local area network (LAN), a wide area network (WAN), and the like), or a combination thereof.

The server 105 may also communicate with the user devices 115 via the communication network 125. Broadly, a user employs the user device 115 receive data from the data producer 110 via the data portal 145. Although not illustrated, the user device 115 may include similar components as the server 105 (an electronic processor, a memory, a communication interface, and the like).

The user device 115 may also include a human-machine interface including one or more input devices, one or more output devices, or a combination thereof. Accordingly, in some embodiments, the human-machine interface allows a user to interact with (for example, provide input to and receive output from) the user device 115. For example, the human-machine interface may include a keyboard, a cursor-control device (for example, a mouse), a touch screen, a scroll ball, a mechanical button, a display device (for example, a liquid crystal display (LCD)), a printer, a speaker, a microphone, or a combination thereof. As illustrated in FIG. 1, in some embodiments, the human-machine interface includes a display device. The display device may be included in the same housing as the user device 115 or may communicate with the user device 115 over one or more wired or wireless connections. For example, in some embodiments, the display device is a touchscreen included in a laptop computer or a tablet computer. In other embodiments, the display device is a monitor, a television, or a projector coupled to a terminal, desktop computer, or the like via one or more cables.

The data producer 110 provides various data, such as market data. In some embodiments, the data producer 110 generates streaming data 150, reference data 155, or a combination thereof. In some embodiments, the streaming data 150 represents data “in motion” generated from market exchanges. For example, the streaming data 150 may identify an instrument's most recent offer to sell or bid to buy. In some embodiments, the reference data represents data “at rest” stored statistically and refers to any type of data related to financial instruments that is not changing in real-time. For example, the reference data 155 includes identifier codes, the exchange the instrument trades on, ticker, currency, payment, frequency, coupon-rate, end-of-day pricing, name and address of the issuing company, the terms of the security (such as dividends or interest rate and maturity on a bond), and the outstanding corporate actions (such as pending stock splits or proxy votes, tender offers, name changes, bankruptcies) related to the instrument. The reference data 155 may be generated by the issuer of the instrument and the data producer 110 may format and organize the reference data 155.

The streaming data 150, the reference data 155, or both may be stored at the data producer 110 (e.g., within a memory of the data producer 110). Alternatively or in addition, the streaming data 150, the reference data 155, or both may be stored within a plurality of databases, such as within a cloud service. Although not illustrated in FIG. 1, the data producer 110 may include components similar to the server 105, such as an electronic processor, a memory, a communication interface, and the like. For example, the data producer 110 may include a communication interface configured to communicate (for example, receive data and transmit data) over the communication network 125. In some embodiments, the data producer 110 includes one or more servers, one or more databases, or the like.

As described in detail below, the data portal 145 provides an interface between the data producer 110 and the user devices 115 to provide security and accountability in a low latency environment. It should be understood that the functionality described herein as being performed by the data portal 145 may be distributed among multiple portals, systems, devices, or the like.

Data regarding transactions occurring through the data portal 145 (e.g., registration, authentication/key requests, consumptions, etc.) related to authorization and consumption of the streaming data 150, the reference data 155, or both can be stored in a distributed ledger 160 (or other database). A distributed ledger 160 is a type of database that provides each member of a system (e.g., the server 105, the data producer 110, users, or combinations thereof) with their own private ledger nimble enough to enable multi-generational contracts to occur simultaneously. In general, a distributed ledger 160 uses independent computers (referred to as nodes) to record, share, and synchronize transactions in their respective electronic ledgers instead of keeping data centralized as in a traditional ledger. A blockchain is one type of distributed ledger but embodiments described herein are not limited to any particular type of distributed ledger. Also, in some embodiments, a centralized ledger may be maintained, such as by the server 105.

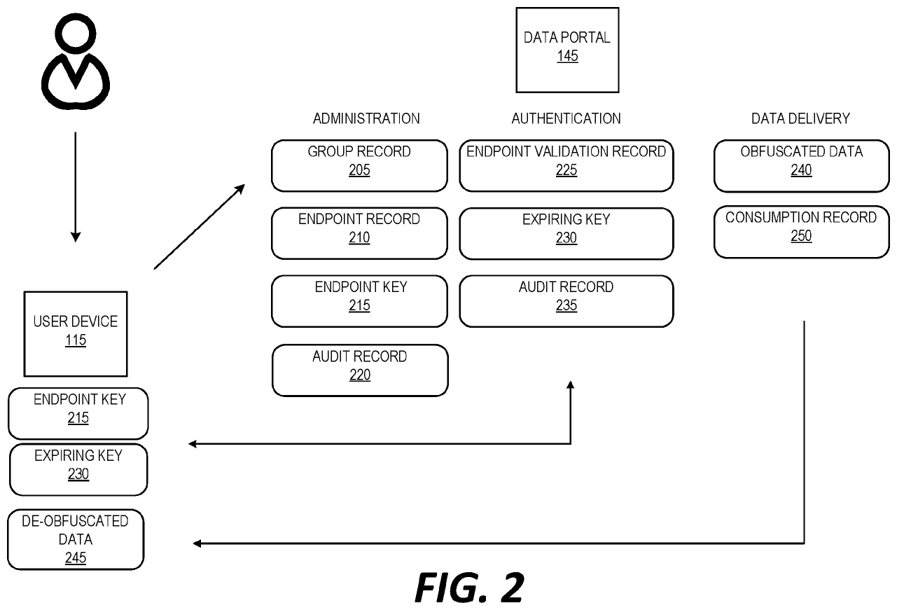

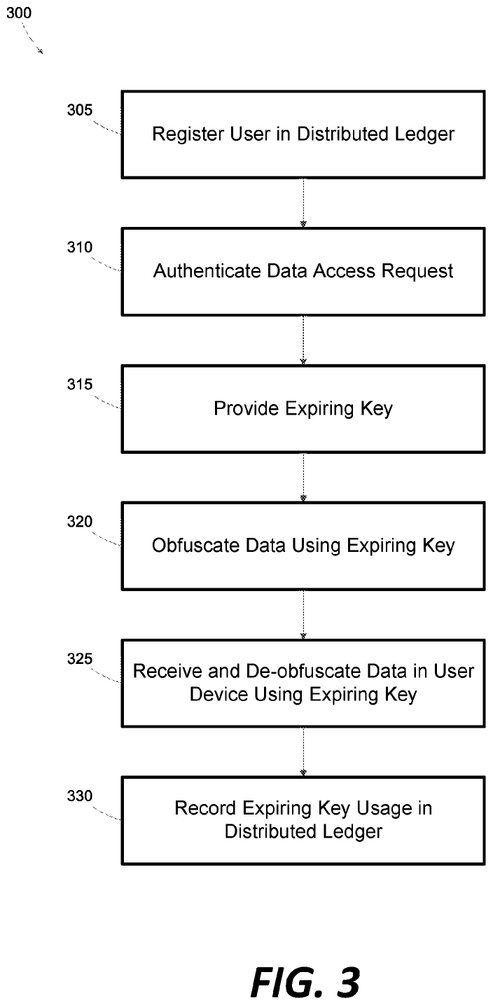

The operation of the system 100 for providing access to data is further described in reference to FIGS. 2 and 3. FIG. 2 is a diagram illustrating data flow between the data portal 145 and a user device 115, according to some embodiments. FIG. 3 is a flowchart illustrating an example method 300 for controlling access to data performed by the system 100 of FIG. 1, according to some embodiments.

In block 305, a user is registered as a consumer of data provided by the data producer 110. This registration may occur through the data portal 145. In some embodiments, this registration is recorded by the server 105. Alternatively or in addition, this registration may be recorded in the distributed ledger 160. In some embodiments, the user may be part of a larger group, such as a firm. In this situation, two levels of registration may be performed—one for the group and one for each individual in the group. For example, when a user is part of a group, the data portal 145 creates a group record 205 identifying the group and one or more endpoint records 210 identifying each user within the group. The group record 205, the endpoint records 210, or both may specify subscription or sub-subscription information identifying the data services to which the user subscribes as well as payment information associated with the subscriptions. The subscription information may refer to various feeds from data producers 110 in the form of streaming data 150 or various sources for reference data 155. In some embodiments, the subscription information may also specify a duration for the data subscription(s), such as a contract month, week, time period, particular days (e.g., only Tuesdays or Monday through Friday) within a time period, or the like. Subscriptions may be customizable for the specific needs of both the data producer 110 and the data consumers and may be driven by any number of requirements related to the expiration of the entitlement contract, intended periods of use, specific markets or contracts, analytics, and other specific categories. In some embodiments, the system 100 can create customized smart contracts based on various pricing models. Smart contracts are auto-executing contracts in which transactions between parties are written into the code and automatically executed with little or no oversight or auditing. For example, smart contracts can allow stock exchanges to optimize contracts depending on each consumer's needs.

In some embodiments, the data portal 145 assigns an endpoint key 215 to the user device 115 as part of the registration process. In some embodiments, the endpoint key 215 is based on (generated from) or associated with (stored or linked with) identification information specific (unique) to the user device 115, such as a hardware address (e.g., a MAC address), an IP address, a secure, embedded identification code (which cannot be transferred between devices), or the like. For example, the endpoint key 215 may be generated from the identifying information. In other embodiments, the endpoint key 215 may be randomly generated but associated with the identifying information in a record (e.g., maintained by the server 105). Accordingly, the endpoint key 215 can uniquely identify the user device 115 that is being registered with the system 100. As described in more detail below, using such an endpoint key can allow the system 200 to detect when an endpoint key has been improperly shared with another device than the device (user device 115) that was originally registered. In some embodiments, the identification information is input by the user as part of the registration process. In some embodiments, the identification information is pulled directly from the user device 115 (e.g., to ensure accurate information is provided). In some embodiments, when the registration process is completed, the data portal 145 generates an audit record 220 identifying authorized user and groups, which can be stored to the distributed ledger 160.

After a user is registered and receives the endpoint key 215 (which is stored on the user's user device 115), the user device 11 can issue data access requests. In some embodiments, these requests are made through the data portal 145, through a separate portal, through a separate software application, or the like. For example, in some embodiments, a user may, via the user device 115, launch a software application for viewing data from the data producer 110. In some embodiments, the user may log in and provide identification data. The identification data may be established as part of the registration process with the system 100 and may include a username, a password, or other credentials or identifying information. In some embodiments, the software application on the user device 115 may access and provide the endpoint key 215 to the data portal 145 for authentication as part of making logging into the software, making a data access request, or both. A data access request may identify the user and/or the associated user device (e.g., per the endpoint key), the data being requested (e.g., streaming or reference data and the particular stream or portion of reference data being requested), and other parameters. However, it should be understood that, in some embodiments, the data request may be automatically generated in response the user launching the application (or accessing a portal) and may request access to any data that the user has subscribed to.

As illustrated in FIG. 2, when the data portal 145 receives a data access request, the data portal 145 authenticates the data access request in block 310. The data portal 145 generates an endpoint validation record 225 responsive to determining that the endpoint is valid (the endpoint key is valid and received from the associated user device 115) and, optionally, payment has been recorded. The data portal 145 can store the endpoint validation record 225 in the distributed ledger 160 (i.e., or a database as noted above). As part of the authentication, the data portal 145 also provides an expiring key 230 to the user device 115 in block 315. The term of the expiring key 230 may vary depending on the particular application, the user's subscription, or the like. For example, the expiring key 230 may expire after the current session, daily, or after some other specified time period. When an expiring key 230 has elapsed, the user device 115 must re-authenticate as described above to get a new expiring key 230, which, again, helps control access to data. In some embodiments, the nature of the expiring key 230 depends on the type data being accessed. For example, for streaming data 150, the expiring key 230 may be the same for a group of users (e.g., for a particular firm or class of users), allowing a multicast delivery approach. In another embodiment, for reference data 155, the expiring key 230 may be unique to the user device 115 specified in the endpoint record 210. In some embodiments, the user device 115 is provided with multiple expiring keys 230, such as a group expiring key for streaming data and a unique expiring key for reference data. In some embodiments, the endpoint validation record 225 records the issuance of the expiring key(s) 230 in the distributed ledger 160. In some embodiments, the data portal 145 generates an audit record 235 identifying authenticated data access requests, which can be stored to the distributed ledger.

In block 320, data provided to the user device 115 from the data producer 110 (as part of an authenticated data access request) is obfuscated using the expiring key 230 to generate obfuscated data 240. In some embodiments, the data is obfuscated by performing an XOR operation on the data (e.g., individual data packets) using the expiring key 230. However, in other embodiments, different ways of obfuscation functions may be used. In some embodiments, the user device 115 receives obfuscated data 240 from the data portal 145, such that the data portal 145 receives the data from the data producer 110, performs the obfuscation, and forwards the obfuscated data to the user device 115. Alternatively, in some embodiments, the data producer 110 also receives the expiring key 230 from the data portal 145, obfuscates the streaming data 150 or the reference data 155 and sends the obfuscated data 240 directly to the user device 115 (rather than through the data portal 145).

In block 325, the user device 115 receives the obfuscated data and uses the expiring key 230 to de-obfuscate the data to allow it to be viewed. In some embodiments, the data is de-obfuscated by performing another XOR operation (or similar de-obfuscation function) to restore the data to its original form. As compared to encryption and decryption, the use of obfuscation and de-obfuscation provides a high-speed operation that introduces little latency into the data generation and consumption, which is particularly relevant to streaming data 150, where its value depends at least in part on its timeliness.

In block 330, a consumption record 250 associated with the usage of the expiring key 230 by the user device 115 is recorded in the distributed ledger 160. In some embodiments, the data portal 145 or the data producer 110 generates the consumption record 250 responsive to the sending the obfuscated data 240 to the user device 115. In some embodiments, a software application on the user device 115 generates the consumption record 250. In some embodiments, the consumption record 250 includes the endpoint key 215 associated with the user device 115, which provides information for auditing consumption of data. For example, in a case where a particular user may share the expiring key 230 with a different user (e.g., on a different user device 115), the consumption recorded generated for any use of the shared expiring key 230 would indicate that the key had been shared. In other words, the consumption record 250 is useful for identifying such key sharing since the endpoint key will not match the particular user device 115 used to consume the data.

The consumption record 250 may also include additional information, such as date and time, length of time access, type of access, actions taken on the accessed data, or the like. This information may be stored in one or more consumption records. In some embodiments, the data portal 145 stores a consumption record 250 even for the use of an expiring keys 230 that has already expired or even when an endpoint key 215 does not match the user device 115 accessing the data (even with a valid expiring key 230). In some embodiments, in these situations, the data portal 145 blocks the delivery of data to the unauthorized user device 115 or for a user device 115 attempting to use an expiring key 230 that has elapsed. However, in other embodiments, in these situations, the data portal 145 allows the consumption to occur as described above but may generate an audit report or billing record (separate from or represented by the consumption record 250) identifying the unauthorized user device 115 or the use of an elapsed expiring key 230 to facilitate billing of the group or individual for the data consumption services.

The distributed ledger 160 (or database as noted above) provides an audit tool that is transparent to specified users that identifies subscription terms, payments, and data usage. The consumers and data producers 110 can track the usage of the endpoint keys 215 and the expiring keys 230 to determine what data was delivered to which user device 115. The distributed ledger 160 provides transparent billing information to both the consumer and the data producer 110. The use of the distributed ledger 160 reduces auditing costs and avoids lost revenue for the data producers 110 as usage can be billed according to the particular consumers.

Accordingly, embodiments described herein provide systems and methods for providing secure and accountable data consumption. For example, through the use of endpoint authentication, requests for access to data can be authenticated as being received from an authorized endpoint, which helps limit cross-pollination through key sharing. In addition, through the use of expiring keys, access to data is only authenticated for a limited amount of time, wherein once a key has expired it can no longer be used to access data. Furthermore, using data obfuscation, data, even if it is received by an unauthorized individual, cannot be consumed because the individual cannot de-obfuscate the data. Also, using obfuscation, as compared to encryption, reduces latencies, which can impact the usefulness of streaming data. Furthermore, the systems and methods provide auditing tools, such as on an immutable ledger, which limit lost revenue to data producers and increase their return on investment. In particular, by recording data consumptions (and not just data requests and/or authorizations) to the ledger, audits can be performed to track actual consumption for billing and accounting purposes (in addition to identifying unauthorized access and consumption).

Various features and advantages of some embodiments are set forth in the following claims.

What is claimed is:

1. A method for controlling access to data, the method comprising:
storing, by an electronic processor, a registration record for a user in a database identifying a first user device associated with the user;
authenticating, by the electronic processor, a data access request from the first user device based on the registration record;
providing, by the electronic processor, a key to the first user device responsive to authenticating the data access request;
sending data obfuscated with the key to the first user device; and
storing a consumption record in the database responsive to an employing of the key to de-obfuscate the data.

2. The method of claim 1, wherein the database comprises a distributed ledger.

3. The method of claim 1, wherein the registration record defines subscription information and payment information for the user.

4. The method of claim 1, wherein the registration record comprises an endpoint key unique to the first user device.

5. The method of claim 4, wherein the endpoint key is based on identification information specific to the first user device.

6. The method of claim 4, wherein the consumption record comprises the endpoint key.

7. The method of claim 1, wherein the key comprises an expiring key valid for a predetermined time interval.

8. The method of claim 7, comprising:
blocking the sending of the data to the first user device responsive to the consumption record indicating an elapsing of the expiring key.

9. The method of claim 7, comprising:
generating, by the electronic processor, a billing record in the database responsive to the consumption record indicating an elapsing of the expiring key.

10. The method of claim 1, comprising:
blocking the sending of the data to a second user device responsive to the consumption record indicating a use of the key by the second user device, wherein the second user device is different from the first user device.

11. The method of claim 1, comprising:
generating, by the electronic processor, a billing record in the database responsive to the consumption record indicating a use of the key by a second user device different from the first user device, wherein the billing record identifies the second user device.

12. The method of claim 1, wherein the key is unique to the first user device.

13. The method of claim 1, wherein the key is shared by a plurality of user devices including the first user device.

14. A system for controlling access to data, comprising:
an electronic processor; and
memory coupled to the electronic processor and storing instructions that, when executed by the electronic processor, cause the system to:
store a registration record for a user in a database identifying a first user device associated with the user;
authenticate a data access request from the first user device based on the registration record;
provide a key to the first user device responsive to authenticating the data access request;
send data obfuscated with the key to the first user device; and
store a consumption record in the database responsive to an employing of the key to de-obfuscate the data.

15. The system of claim 14, wherein the registration record defines subscription information and payment information for the user.

16. The system of claim 14, wherein the registration record comprises an endpoint key unique to the first user device, wherein the endpoint key is based on identification information specific to the first user device.

17. The system of claim 16, wherein the consumption record comprises the endpoint key.

18. The system of claim 14, wherein the key comprises an expiring key valid for a predetermined time interval.

19. The system of claim 18, wherein the instructions, when executed by the electronic processor, cause the system to:
generate a billing record in the database responsive to the consumption record indicating an elapsing of the expiring key.

20. The system of claim 14, wherein the instructions, when executed by the electronic processor, cause the system to:
generate a billing record in the database responsive to the consumption record indicating a use of the key by a second user device different from the first user device, wherein the billing record identifies the second user device.
